(19) United States
(12) Patent Application Publication
(10) Pub. No.: US 2015/0235246 A1
(43) Pub. Date: Aug. 20, 2015

(54) CROSS-CHANNEL AUDIENCE SEGMENTATION

(71) Applicant: Kenshoo Ltd., Tel Aviv (IL)

(72) Inventors: Arriel Johan BENIS, Rehovot (IL); Tal Hasson, Petach Tikva (IL); Eyal Sadeh, Herzelia (IL); Noam Barkai, Aderet (IL); Noam Hasson, Herzliya (IL); Itai Marks, Tel Aviv (IL); Moti Meir, Modiin (IL)

(21) Appl. No.: 14/623,738

(22) Filed: Feb. 17, 2015

Related U.S. Application Data
(60) Provisional application No. 61/942,139, filed on Feb. 20, 2014.

(51) Int. Cl. G06Q 30/02

(52) U.S. Cl. CPC G06Q 30/0204; G06Q 30/0256

(57) ABSTRACT

A method comprising using at least one hardware processor for: receiving first a set of keywords associated with a first advertising platform; receiving second a set of keywords associated with a second advertising platform; defining binary relations between the first and second sets of keywords; applying formal concept analysis (FCA) to the binary relations, to produce a concept lattice; and updating the concept lattice responsive to changes in the first or second sets of keywords.

### CROSS-REFERENCE TO RELATED APPLICATIONS

This application claims the benefit of U.S. Provisional Patent Application No. 61/942,139, filed Feb. 20, 2014 and entitled “Cross-Channel Audience Segmentation”, which is incorporated herein by reference in its entirety.

### FIELD OF THE INVENTION

Present embodiments relate to the field of online advertising.

### BACKGROUND

Advertising using traditional media, such as television, radio, newspapers and magazines, is well known. Unfortunately, even when armed with demographic studies and entirely reasonable assumptions about the typical audience of various media outlets, advertisers recognize that much of their advertising budget is oftentimes simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their advertisements (also “ads”) to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif., delivers ads targeted to keywords from search queries. Similarly, content-targeted ad delivery systems have been proposed. For example, U.S. Pat. No. 7,716,161 to Dean et al. and U.S. Pat. No. 7,136,875 to Anderson et al. describe methods and apparatuses for serving ads relevant to the content of a document, such as a web page. Content-targeted ad delivery systems, such as the AdSense advertising system by Google for example, have been used to serve ads on web pages.

AdSense is part of what is often called advertisement syndication, which allows advertisers to extend their marketing reach by distributing advertisements to additional partners. For example, third party online publishers can place an advertiser's text or image advertisements on web pages that have content related to the advertisement. This is often referred to as “contextual advertising”. As the users are likely interested in the particular content on the publisher web page, they are also likely to be interested in the product or service featured in the advertisement. Accordingly, such targeted advertisement placement can help drive online customers to the advertiser's website.

Optimal ad placement has become a critical competitive advantage in the Internet advertising business. Consumers are spending an ever-increasing amount of time online, looking for information. The information, provided by Internet content providers, is viewed on a page-by-page basis. Each page can contain written and graphical information as well as one or more ads. Key advantages of the Internet, relative to other information media, are that each page can be customized to fit a customer profile and ads can contain links to other Internet pages. Thus, ads can be directly targeted at different customer segments. For example, ad targeting is nowadays possible based on the geographic location of the advertiser and/or the customer, the past navigation path of the customer outside or within the web site, the language used by the visitor's web browser, the purchase history on a website, the behavioral intent influenced by the user's action on the site, and more.

Furthermore, the ads themselves are often designed and positioned to form direct connections to well-designed Internet pages. The concept referred to as “native advertising” offers ads which more naturally blend into a page's design, in cases where advertiser's intent is to make the paid advertising feel less intrusive and, therefore, increase the likelihood users will click on it.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment provides a method comprising using at least one hardware processor for: receiving first a set of keywords associated with a first advertising platform; receiving second a set of keywords associated with a second advertising platform; defining binary relations between the first and second sets of keywords; applying formal concept analysis (FCA) to the binary relations, to produce a concept lattice; and updating the concept lattice responsive to changes in the first or second sets of keywords.

Another embodiment provides a computer program product for cross-channel audience segmentation, the computer program product comprising a non-transitory computer-readable storage medium having program code embodied therewith, the program code executable by at least one hardware processor for: receiving first a set of keywords associated with a first advertising platform; receiving second a set of keywords associated with a second advertising platform; defining a binary relation between the first and second sets of keywords; applying formal concept analysis (FCA) to the binary relation, to produce a concept lattice; and updating the concept lattice responsive to changes in the first or second sets of keywords.

In some embodiments, the method further comprises using said at least one hardware processor for: extracting association rules from the concept lattice; selecting extracted association rules by collaborative filtering; and producing a cross-channel audience segmentation report.

In some embodiments, the method further comprises using said at least one hardware processor for effecting at least one action in at least one of said first and second advertising platforms, the at least one action selected from the group consisting of: adding one or more keywords to an advertising campaign, removing one or more keywords from an advertising campaign, adding one or more negative keywords to an advertising campaign, removing one or more negative keywords from an advertising campaign, initiating a new advertising campaign, stopping an advertising campaign, and changing ad copy.

In some embodiments, said updating of the concept lattice is incremental updating of the concept lattice.

In some embodiments, the method further comprises using said at least one hardware processor for combining similar keywords.

In some embodiments, the defining of the binary relation comprises: collecting anonymous cookie data from Internet users clicking on online advertisements; and using the cookie data, cross-referencing activity associated with the first advertising platform and the second advertising platform.

In some embodiments, the anonymous cookie data is devoid of a real identity of the Internet users.

In some embodiments, the method further comprises maintaining an ad-centric database which comprises the cross-referenced activity.

In some embodiments, the cross-referencing comprises constructing anonymous demographic profiles of the Internet users.

In some embodiments, the method further comprises maintaining an ad-centric database which comprises the cross-referenced activity and the anonymous demographic profiles.

In some embodiments, the program code is further executable by the at least one hardware processor for: extracting association rules from the concept lattice; selecting extracted association rules by collaborative filtering; and producing a cross-channel audience segmentation report.

In some embodiments, the program code is further executable by the at least one hardware processor for effecting at least one action in at least one of said first and second advertising platforms, the at least one action selected from the group consisting of: adding one or more keywords to an advertising campaign, removing one or more keywords from an advertising campaign, adding one or more negative keywords to an advertising campaign, removing one or more negative keywords from an advertising campaign, initiating a new advertising campaign, stopping an advertising campaign, and changing ad copy.

In some embodiments, the program code is further executable by the at least one hardware processor for combining similar keywords.

In some embodiments, the program code is further executable by the at least one hardware processor for maintaining an ad-centric database which comprises the cross-referenced activity.

In some embodiments, the program code is further executable by the at least one hardware processor for maintaining an ad-centric database which comprises the cross-referenced activity and the anonymous demographic profiles.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. The figures are listed below:

FIG. 1 shows a schematic of an example of a cloud computing node;

FIG. 2 shows an illustrative cloud computing environment;

FIG. 3 shows a set of functional abstraction layers provided by the cloud computing environment of FIG. 2;

FIG. 4 shows a flowchart of a method for cross-channel audience segmentation; and

FIG. 5 shows an exemplary concept lattice.

### DETAILED DESCRIPTION

### Glossary

“Online advertising platform” (or simply “advertising platform”): This term, as referred to herein, may relate to a service offered by an advertising business to different advertisers. In the course of this service, the advertising business serves ads, on behalf of the advertisers, to Internet users. Each advertising platform usually services a large number of advertisers, who compete on advertising resources available through the platform. The competition is oftentimes carried out by conducting some form of an auction, where advertisers bid on advertising resources. The ads may be displayed (and/or otherwise presented) in various web sites which are affiliated with the advertising business (these web sites constituting what is often referred to as a “display network”) and/or in one or more web sites operated directly by the advertising business. To aid advertisers in neatly organizing their ads, advertising platforms often allow grouping individual ads in sets, such as the “AdGroups” feature in Google AdWords (a service operated by Google, Inc. of Mountain View, Calif.). The advertiser may decide on the logic behind such grouping, but it is common to have ads grouped by similar ad copies, similar targeting, etc. Advertising platforms may allow an even more abstract way to group ads; this is often called a “campaign”. A campaign usually includes multiple sets of ads, with each set including multiple ads. An advertiser may control the cost it spends on online advertising by assigning a budget per individual ad, a group of ads or the like. The budget may be defined for a certain period of time.

“Search advertising platform”: A type of advertising platform in which ads are served to Internet users responsive to search engine queries executed by the users. The ads are typically displayed alongside the results of the search engine query. AdWords is a prominent example of a search advertising platform. In AdWords, advertisers can choose between displaying their ads in a display network and/or in Google's own search engine; the former involves the subscription of web site operators (often called “publishers”) to Google's AdSense program, whereas the latter, often referred to as SEM (Search Engine Marketing), involves triggering the displaying of ads based on keywords entered by users in the search engine.

“Social advertising platform”: A further type of advertising platforms, commonly referred to as a “social” advertising platform, involves the displaying of ads to users of online social networks. An online social network is often defined as a set of dyadic connections between persons and/or organizations, enabling these entities to communicate over the Internet. In social advertising, both the advertisers and the users enjoy the fact that the displayed ads can be highly tailored to the users viewing them. This feature is enabled by way of analyzing various demographics and/or other parameters of the users (jointly referred to as “targeting criteria”)—parameters which are readily available in many advertising platforms of social networks and are usually provided by the users themselves. These parameters correspond, in a sense, to the “keywords” used in search advertising platforms. Facebook Ads, operated by Facebook, Inc. of Menlo Park, Calif., is such an advertising platform. LinkedIn Ads, by LinkedIn Corporation of Mountain View, Calif., is another.

“Online ad entity” (or simply “ad entity”): This term, as referred to herein, may relate to an individual ad, or, alternatively, to a set of individual ads, run by an advertising platform. An individual ad, as referred to herein, may include an ad copy, which is the text, graphics and/or other media to be served (displayed and/or otherwise presented) to users. In addition, an individual ad may include and/or be associated with a set of parameters, such as searched keywords to target, geographies to target, demographics to target, a bid for utilization of advertising resources of the advertising platform, and/or the like. Sometimes, the bid may set for a particular parameter instead of or in addition to setting a global bid for the ad entity; for example, a bid may be per keyword, geography, etc.

“Reach”: the number of users which fit certain targeting criteria of an ad entity. This is the number of users to which that ad entity can be potentially displayed. The “reach” metric is common in social advertising platforms, such as Facebook.

“Search volume”: the number of average monthly searches (or searches over another period of time) for a certain search term. The search volume is often provided by search advertising platforms, such as Google AdWords.

“Performance”: This term, as referred to herein with regard to an ad, may relate to various statistics gathered in the course of running the ad. A “running” phase of the ad may refer to a duration in which the ad was served to users, or at least to a duration during which the advertiser defined that the ad should be served. The term “performance” may also relate to an aggregate of various statistics gathered for a set of ads, a campaign, etc. The statistics may include multiple parameters (also “performance metrics”). Exemplary performance metrics are:
“Impressions”: the number of times the ad has been served to users during a given time period (e.g. a day, an hour, etc.);
“Frequency”: the average number of times a user has been exposed to the same ad, calculated as the ratio of total number of impressions to the number of unique impressions (i.e. the number of unique users exposed to that ad). This metric is very common in social advertising platforms;
“Clicks”: the number of times users clicked (or otherwise interacted with) the ad entity during a given time period (e.g. a day, an hour, etc.);
“Cost per click (CPC)”: the average cost of a click (or another interaction with an ad entity) to the advertiser, calculated as the total cost for all clicks divided by the number of clicks;
“Cost per impression”: the average cost of an impression to the advertiser, calculated as the total cost for all impressions divided by the number of impressions;
“Click-through rate (CTR)”: the ratio between clicks and impressions of the ad entity, namely—the number of clicks divided by the number of impressions;
“Conversions”: the number of times in which users who clicked (or otherwise interacted with) the ad entity have consecutively accepted an offer made by the advertiser during a given time period (e.g. a day, an hour, etc.). For examples, users who purchased an advertised product, users who subscribed to an advertised service, users who downloaded a mobile application, or users who filled in their details in a lead generation form;
“Conversion rate (CR)”: the total number of conversions divided by the total number of clicks;
“Return on investment (ROI)” or “Return on advertising spending (ROAS)”: the ratio between the amount of revenue generated as a result of online advertising, and the amount of investment in those online advertising efforts. Namely—revenue divided by expenses;
“Revenue per click”: the average amount of revenue generated to the advertiser per click (or another interaction with an ad entity), calculated by dividing total revenue by total clicks;
“Revenue per impression”: the average amount of revenue generated to the advertiser per impression of the ad entity, calculated by dividing total revenue by total impressions;
“Revenue per conversion”: the average amount of revenue generated to the advertiser per conversion, calculated by dividing total revenue by total conversions;
“Unique-impressions-to-reach ratio”: the ratio between the number of unique impressions (i.e. impressions by different users, ignoring repeated impressions by the same user) and the reach of the ad entity. This ratio represents the realized portion of the reach.
“Spend rate”: the percentage of utilized budget per a certain time period (e.g. a day) for which the budget was defined. In many scenarios, even if an advertiser assigns a certain budget for a certain period of time, not the entire budget is consumed during that period. The spend rate metric measures this phenomenon.
“Quality score”: a score often provided by advertising platforms for each ad entity. For example, Google AdWords assigns a quality score between 1 and 10 to each individual ad. Factors which determine the quality score include, for example, CTR, ad copy relevance, landing page quality and/or other factors. The quality score, together with the bids placed by the advertiser, are usually the factors which affect the results of the competition between different advertisers on advertising resources.
“Potential reach”: defined as 1 minus the unique-impressions-to-reach ratio. The higher the potential reach, the more users are left to display the ad entity to.

“Proportional performance metrics”: those of the above performance metrics (or other performance metrics not discussed here) which denote a proportion between two performance metrics which are absolute values. Merely as one example, CTR is a proportional performance metric since it denotes the proportion between clicks (an absolute value) and impressions (another absolute value). As an alternative, a proportional performance metric may be a proportion between an absolute performance metric and another parameter, such as time. As yet another alternative, a proportional performance metric may be a certain mathematic manipulation of a proportion between two absolute performance metrics; the “potential reach” is an example, since it is defined as 1 minus the unique-impressions-to-reach ratio.

### Detailed Description of Embodiments

Disclosed herein are methods useful in gaining insight as to demographics of Internet users who interact with online ad entities. Advantageously, the method utilizes data gathered from multiple advertising platforms, such as two platforms, three platforms, or even four or more platforms. Optionally, among the multiple advertising platforms are at least one social advertising platform and at least one search advertising platform. This enables combining and utilizing different types of data that each such advertising platform provides.

In the present description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As will be appreciated by one skilled in the art, aspects of the present invention may be embodied as a system, method, apparatus or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described here with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

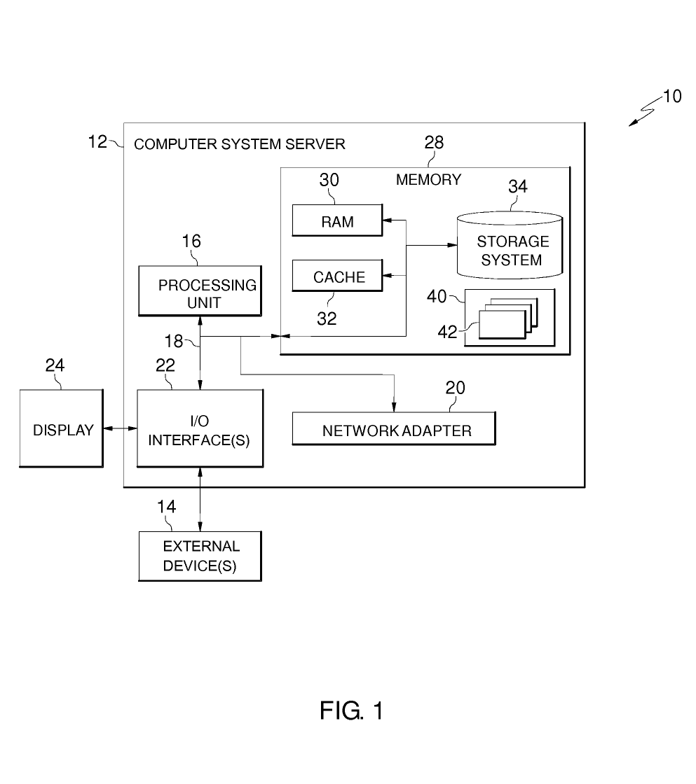

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system.

Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

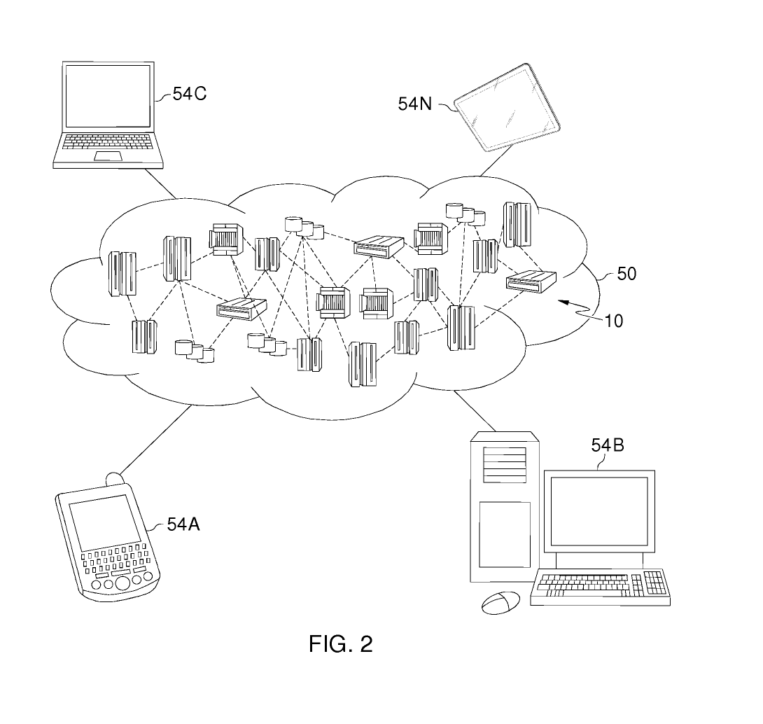

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer MB, laptop computer 54C, and/or tablet computing device 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

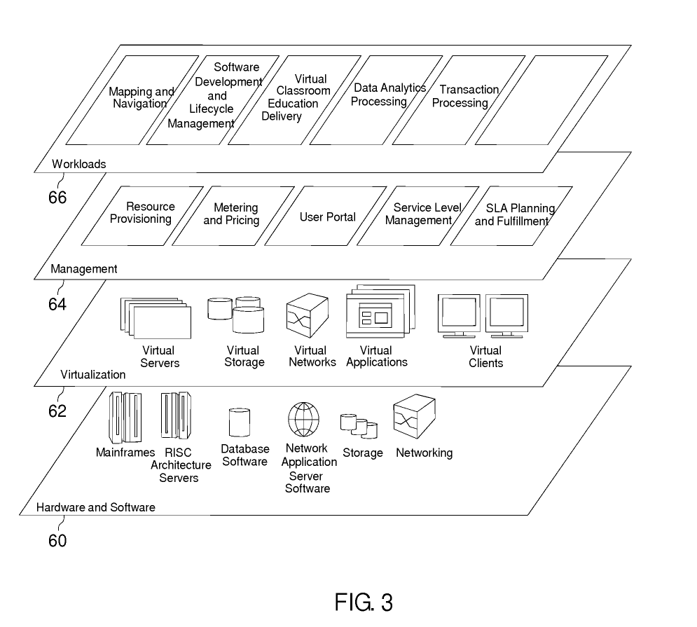

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, RISC (Reduced Instruction Set Computer) architecture based servers; storage devices; networks and networking components. Examples of software components include network application server software; and database software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; and data analytics processing; transaction processing.

As briefly discussed above, disclosed herein are methods useful in gaining insight as to demographics of Internet users who interact with online ad entities.

The present methods may reveal, for example, how to use data related to a group of users (e.g. fans) of a social network (associated with a social advertising platform) in search engine advertising campaigns, in order to expand the number of the social network users which are part of this group (i.e., how to improve user acquisition).

Another example is how to optimize performance of search engine advertising campaigns by improving the keyword expansion process based on adding user interests disclosed in a social network. A keyword expansion process is often described as an incremental process of adding keyworks to the targeting criteria of a search engine advertising campaign, based on various insights gathered during the running of that campaign or associated campaign(s).

A further example is how to create more compelling ad copy in order to increase CTR, by using keywords searched in a search engine by a subset of members of a group (e.g. fans) of the social network users during a previous period.

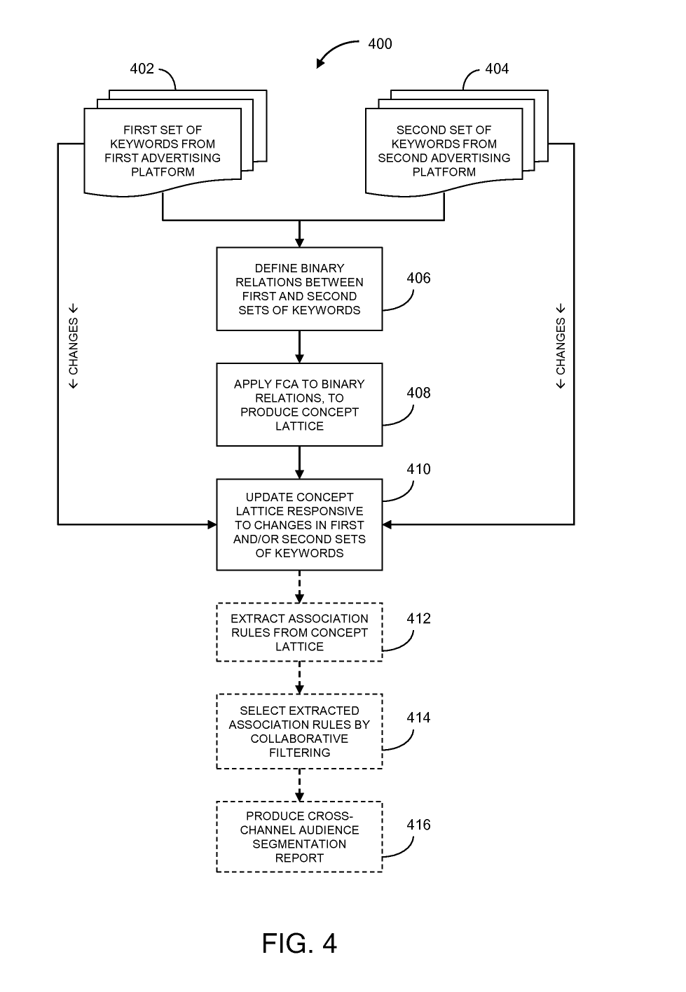

Reference is now made to FIG. 4, which shows a flowchart of a method 400 for cross-channel audience segmentation, in accordance with an embodiment. This exemplary method refers to cross-referencing only two channels (i.e. information from two advertising platforms), for simplicity of discussion. However, those of skill in the art will recognize that the method is applicable to more than two channels, with the necessary modifications.

In an initial step, a first set of keywords, associated with a first advertising platform, may be received 402. For example, the first advertising platform may be a search advertising platform, and the first set of keywords may include single words and/or multi-word phrases which, after having been enetered by users as search queries, were used to trigger ads in the search advertising platform. The first set of keywords may have been accumulated over a certain period of time, such as in the range of minutes, hours, days, weeks, months or even more. To this end, manual or automatic interfacing with the first advertising platform may be commenced, to retrieve the first set of keywords. Manual retrieval may be conducted, for example, through a web-based user interface of the first advertising platform, which interface includes a functionality to export the first set of keywords to a file. Automatic retrieval may be conducted, for example, through an API (Application Programming Interface) of the first advertising platform, which enables a software program operative in accordance with method 400 to access a database of the first advertising platform and retrieve the first set of keywords.

Further in the initial step, a second set of keywords, associated with a second advertising platform, may be received 404. For example, the second advertising platform may be a social advertising platform, and the second set of keywords may include single words and/or multi-word phrases which, if appearing in a list of interests and/or in demographic information of users, were used to trigger ads in the social advertising platform. The second set of keywords may have been accumulated over a certain period of time, such as in the range of minutes, hours, days, weeks, months or even more. To this end, manual or automatic interfacing with the second advertising platform may be commenced, to retrieve the second set of keywords. Manual retrieval may be conducted, for example, through a web-based user interface of the second advertising platform, which interface includes a functionality to export the second set of keywords to a file. Automatic retrieval may be conducted, for example, through an API (Application Programming Interface) of the second advertising platform, which enables a software program operative in accordance with method 400 to access a database of the second advertising platform and retrieve the second set of keywords.

In an optional step (not shown), intra-set keyword pruning is performed, to combine similar keywords. The combining of similar keywords may be performed according to one or more of the following principles:

One, detection of keywords which are linguistically similar, and deletion of all but one of such similar keywords. For instance, keywords having the same grammatical stem but appearing in multiple grammatical inflections, tenses, etc.—may be pruned, such that they remain represented, in the set, by a single keyword. This type of pruning may reduce noise which might interfere with analysis performed later in the framework of method 400.

Two, detection of keywords which represent the same or a similar demographic meaning, and deletion of all but one of such similar keywords; or, alternatively, implanting of a new keyword in the set, which represents all of these similar keywords. For instance, a user of method 400 may decide to equally treat Internet users which performed searches for city names inside the same state; accordingly, by way of example, the keywords “Seattle”, “Tacoma”, “Olympia”, “Port Angeles” will all be replaced by “Washington”. As another example, a user of method 400 may decide to treat users of a social network on a decade basis, namely—cluster together all users born in the same decade. Accordingly, a “birth year” demographic datum appearing in the second set of keywords may be clustered decade wise; for example, “1981”, “1983” and “1989” may be clustered into “1980's”. Yet in another example, keywords may be clustered according to similarity of their performance data, for example as described in applicant's U.S. Pat. No. 8,856,130, issued Oct. 7, 2014, and entitled “System, a method and a computer program product for performance assessment”.

In a step 406, binary relations between the first and second sets of keywords may be defined. This may include cross-referencing the first and second sets, to determine whether the same or a similar keyword appears in both sets. If it does, this keyword may be defined with a positive binary relation (e.g., “1”, “yes”, etc.); if it does not, this keyword may be defined with a negative binary relation (e.g., “0”, “no”, etc.).

In a step 408, formal concept analysis (FCA) may be applied to the binary relations, to produce a concept lattice. FCA, as known in the field of information science, is a principled way of deriving a concept hierarchy or formal ontology from a collection of objects (here: keywords) and their properties (here: the defined binary relation—positive or negative). Each concept in the hierarchy represents the set of objects sharing the same values for a certain set of properties; and each sub-concept in the hierarchy contains a subset of the objects in the concepts above it.

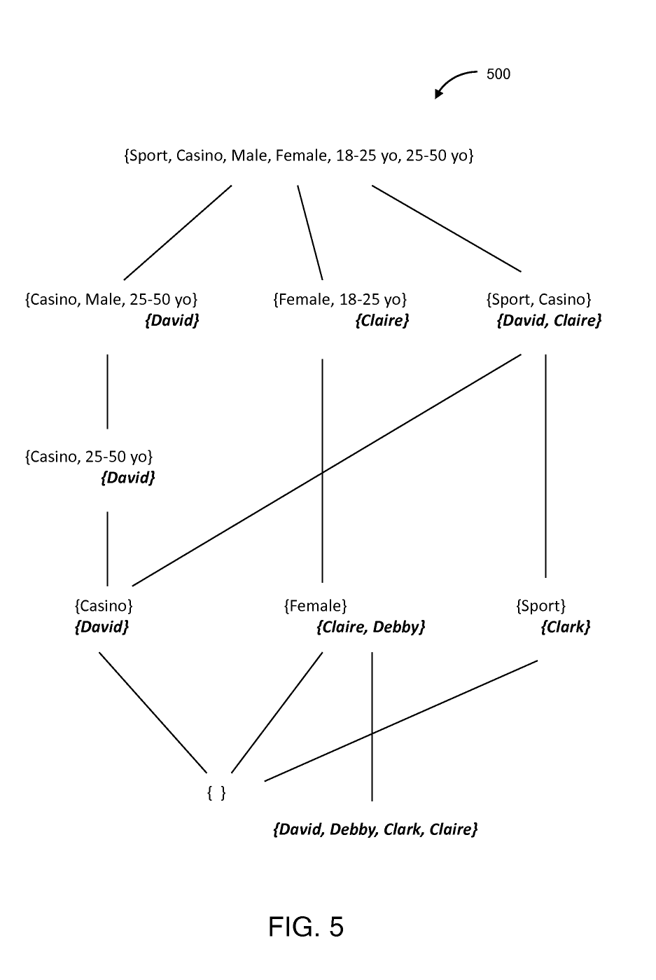

When applied to the present method, the concept lattice resulting from the FCA application may be indicative of an intensity of correlation between pairs of keywords, one from the first set and the other from the second set. This may provide useful insight for an advertiser. Interim reference is now made to FIG. 5, which shows an exemplary, simplistic, concept lattice 500. User IDs are shown in bold, italicized text—and are given as first names merely for simplicity of discussion (in reality, these may be anonymous unique IDs). An advertiser reviewing this concept lattice may derive the following advantageous insights from it:
David is a man/male, aged between 25 and 50 years. He is interested in sports and casino.
Debby is a woman/female.
Clark is interested in sports and casino.
Claire is a female aged between 18 and 25 years.

Reference is now made back to FIG. 4. Method 400 may utilize a specially-crafted FCA tool, or FCA software available on the market, such as the open-source tools ConExp, ToscanaJ, Lattice Miner, Coron, FcaBedrock or the like. Further suitable tools are listed in Uta Priss, “FCA Software”, 2007, online: http://www.fcahome.org.uk/fcasoftware.html (last viewed Feb. 14, 2015).

In a step 410, the concept lattice produced in step 408 may be updated responsive to changes in the first 402 and second 404 sets of keywords. That is, since keywords may change constantly while advertising campaigns are running, the concept may quickly become outdated.

Updating the concept lattice may be performed, for example, in one of the following manners: First, the entire first 402 and second 404 sets of keywords may be received again, and FCA may be applied to them de novo. Second, to save on computing resources, an algorithm suitable for incrementally updating the concept lattice responsive to changes in the first or second sets of keywords may be employed. An exemplary suitable algorithm is the Godin algorithm. See Robert Godin, Rokia Missaoui, Hassan Alaoui, “Incremental concept formation algorithms based on Galois (concept) lattices”, Computational Intelligence (1995), 11(2), 246-267, which is incorporated herein by reference in its entirety. The results, in either case, is an updated concept lattice.

In an optional step 412, association rules may be extracted (also “learned”) from the concept lattice, as known in the art. Association rule learning is a well researched method for discovering interesting relations between variables in large databases. It is intended to identify strong rules discovered in databases using different measures of interestingness. Based on the concept of strong rules, Rakesh Agrawal et al. introduced association rules for discovering regularities between products in large-scale transaction data recorded by point-of-sale (POS) systems in supermarkets. For example, the rule {onions, potatoes} [symbol] {burger} found in the sales data of a supermarket would indicate that if a customer buys onions and potatoes together, they are likely to also buy hamburger meat. See Agrawal, R.; Imieliński, T.; Swami, A. (1993), “Mining association rules between sets of items in large databases”, Proceedings of the 1993 ACM SIGMOD international conference on Management of data, p. 207. Such information can be used as the basis for decisions about online advertising activities.

Then, in an optional step 414, extracted association rules may be selected by collaborative filtering (CF), as known in the art. Collaborative filtering is the process of filtering for information or patterns using techniques involving collaboration among multiple agents, viewpoints, data sources, etc. The collaborative filtering, here, may prune the extracted association rules according, for example, to their quality and/or content.

In a further optional step 416, a cross-channel audience segmentation report may be produced, based on either: the concept lattice of steps 408 or 410; the association rules of step 412; or the selected association pulse of step 414.

The cross-channel audience segmentation report may be used for affecting changes to advertising campaign(s) in one of both the advertising platforms. For example, these changes may include actions such as: adding one or more keywords to an advertising campaign, removing one or more keywords from an advertising campaign, adding one or more negative keywords to an advertising campaign, removing one or more negative keywords from an advertising campaign, initiating a new advertising campaign, stopping an advertising campaign, and/or changing ad copy. These actions may be affected through APIs of the first and/or second advertising platforms.

The cross-channel audience segmentation report may be presented to the advertiser, to provide useful insight on its advertising efforts. For example, when displayed to a certain advertiser which runs campaigns in multiple advertising platforms, the report may provide one or more of the following exemplary insights, inter alia:
Users who like or are interested in topic X, also usually search for Y.
People who bought my product P also interested in topic T.
What products are searched for by people with a social profile corresponding to some constraints, i.e. having certain demographic characteristics.
What are the social target audiences related to my top search terms S.
What are the top search terms S related to my social ads and/or social pages.
What are other interests of people with social profiles corresponding to some constraints, i.e. having certain demographic characteristics.
Relations between various performance matrices, across different advertising channels. For example: “Search term S” having a CTR between 0.04 and 0.06 is related to “Likes and Interests L” of social ads having a CTR between 0.003 and 0.005 and targeting single people living in the USA, aged between 18-25 years old.

Advertisers are usually keen to learn about the synergy between their different advertising channels and to understand the interaction and impact of one channel on the other. Moreover, an advertiser may like to be able to build audiences based on this insight, and optimize advertising activity in one channel, based on insights from the other channel.

Below are exemplary tables with details as to types and structure of data which may be gathered and cross-referenced from different advertising platforms:

TABLE 1
(search performance data)

| Campaign | Adgroup | Keyword | Match Type | Keyword ID |
|---|---|---|---|---|
| Brand | Brand Terms | brand.com | Broad | K1 |
| Products | Digital Cameras | cannon 60d | Broad | K2 |

| Campaign | Ad ID | Impressions | Clicks | Cost | Conversions | Revenue |
|---|---|---|---|---|---|---|
| Brand | A1 | 1000 | 200 | 100$ | 3 | 300$ |
| Products | A3 | 200 | 50 | 20$ | 2 | 1300$ |

TABLE 2
(social performance data)

| | | | | | | | L&I (Likes |
|---|---|---|---|---|---|---|---|
| | | | | | | | and Interests) |
| Campaign | Ad Set | Ad | Ad ID | Image | Age | Gender | Sports |
| Digital Cameras | 25-36_male | Promo_50% | A1 | cannon.jpg | 25-36 | Male | No |
| Digital Cameras | 25-36_female | Promo_50% | A2 | cannon.jpg | 25-36 | Female | No |

| Campaign | L&I Fashion | Impressions | Clicks | Cost | Conversions | Revenue |
|---|---|---|---|---|---|---|
| Digital Cameras | Yes | 5000 | 100 | 300$ | 1 | 850$ |
| Digital Cameras | Yes | 9000 | 150 | 350$ | 3 | 1100$ |

TABLE 3
(real-time bidding data from a social advertising network)

| Campaign | Ad | Ad ID | Image | Segment |
|---|---|---|---|---|
| Digital | Promo_50% | A1 | cannon.jpg | Visited Electronics |
| Cameras | | | | Category in Domain X |
| | | | | and didn't buy |
| Digital | Promo_50% | A2 | cannon.jpg | Gadget Lovers |
| Cameras | | | | |

| Campaign | Impressions | Clicks | Cost | Conversions | Revenue |
|---|---|---|---|---|---|
| Digital | 5000 | 100 | 200$ | 4 | 3200$ |
| Cameras | | | | | |
| Digital | 1000 | 30 | 50$ | 9 | 5300$ |
| Cameras | | | | | |

TABLE 4
(Event-level data - “user path”)

| Time | User ID | Cookie ID | Event Type | Quantity |
|---|---|---|---|---|
| 2014-01-02 00:15:23 | u123A | 123DF | Visit | 1 |
| 2014-01-03 11:15:23 | u123A | 234SK | Impression | 1 |
| 2014-01-03 15:17:23 | u123A | 123DF | Click | 1 |
| 2014-01-03 15:25:23 | u123A | 123DF | Sale | 1 |

| | | | | Search |
|---|---|---|---|---|
| Time | Value | Ad ID | Keyword ID | Term |
| 2014-01-02 00:15:23 | 0 | | | |
| 2014-01-03 11:15:23 | 0 | Facebook- | | |
| | | A2 | | |
| 2014-01-03 15:17:23 | 0 | Google-A3 | Google-K1 | cannon 60d |
| | | | | online |
| 2014-01-03 15:25:23 | 850$ | | | |

A further aspect of present embodiments relates to cross-channel user identification, which enables gaining cross-channel insight on individual Internet users, optionally while preserving their privacy. To this end, step 406, in which binary relations between the first and second sets of keywords are defined, may further include the following actions: First, collecting anonymous cookie data from Internet users clicking on online advertisements in both the first and second advertising platforms. Second, using the cookie data to cross-reference activity of those Internet users in the first advertising platform and the second advertising platform Such cross-channel user identification may overcome privacy issues that may be associated with tracking specific users across different channels.

Cookie-based storage may be an advantageous way to combine data from multiple advertising platforms, such as the exemplary data shown in Tables 1-4, and gather insights based on it. For example, with the above data on user activity and advertising activity, one may conclude and store:

TABLE 5
(cross-channel user identification)

| User ID | Keywords | Search Terms | Age | Gender |
|---|---|---|---|---|
| u123A | cannon 60d | cannon 60d online | 25-36 | Female |

| User ID | Gender | Segments | L&I | Conv. | Revenue |
|---|---|---|---|---|---|
| u123A | Female | Gadget Lovers | Fashion | 1 | 850$ |

The User ID field may be an arbitrary designation of a user, which maintains the user's anonymity by not including the real identity of that user. The User ID filed may be a unique character string, for example a value of a “cookie-value” attribute from a cookie of that user. Alternatively, to maintain an even higher level of anonymity, a non-reversible computation of an arbitrary User ID may be performed based on the value of the “cookie-value” attribute, such that the “cookie-value” attribute is not stored and cannot be later deduced.

Data such as shown in Table 5 may be saved for a large number of users, and may be referred to as “ad/targeting-level data”, since it is devoid of a real-world user identifier. It can be utilized in order to run analysis and generate rules based on the data, such as:
80% of the people who search for “cannon 60d online” are female in the age of 25-36.
15% of the female users who converted in the last 7 days are “Gadget Lovers”.
5% of the female users who converted in the last 7 also looked for product related terms in search engines.

This data may also be utilized for further advertising in a real-time bidding (RTB) on a social advertising platform, based on additional data about the user, such as:
Advertiser may want to advertise on RTB but target only female users for a certain promotion and male users for a different promotion.
Advertiser may want to advertise in RTB and place higher bid for users in a certain age range.

In some embodiments, an ad-centric database may be maintained, which includes the ad/targeting-level data across the different channels. For example, the ad-centric database may include information as to activity of Internet users, which is cross-referenced between two or more different advertising platforms. In addition, optionally, the ad-centric database may include anonymous demographic profiles of those Internet users, which profiles are compiled by combining information as to the users from one or more of the different advertising platforms. The ad-centric database may be stored in a non-volatile memory of a computing device.

The following is an example of using one social ad and enriching it using the ad/targeting-level data. For example, this may be a Facebook ad with ID A2 from the above data samples. For the purpose of this example, we shall assume we receive the event level data mentioned above and aggregated data per channel mentioned above. Then, one can enrich the information on Facebook-A2 as follows:

TABLE 6
(enrichment of social ad)

| | Ad | | | |
|---|---|---|---|---|
| Channel | ID | Keywords | Search Terms | Segments |
| Facebook | A2 | cannon 60d: | cannon 60d | Gadget Lovers: |
| | | clicks = 1, | online: | clicks = 1, |
| | | conversions = 1, | clicks = 1, | conversions = 1, |
| | | revenue = 850$ | conversions = 1, | revenue = 850$ |
| | | | revenue = 850$ | |

Now, assume we receive another event from a different user, as follows:

TABLE 7
(additional event from a different user)

| Time | User ID | Cookie ID | Event Type | Quantity |
|---|---|---|---|---|
| 2014-01-03 17:17:23 | F146B | 234TD | Click | 1 |

| Time | Value | Ad ID | Keyword ID | Search Term |
|---|---|---|---|---|
| 2014-01-03 17:17:23 | 0 | Google-A3 | Google-K1 | buy cannon |
| | | | | 60d |

We can them update and enrich the ad level as follows:

TABLE 8
(enriched ad level)

| | Ad | | | |
|---|---|---|---|---|
| Channel | ID | Keywords | Search Terms | Segments |
| Facebook | A2 | cannon 60d: | cannon 60d | Gadget Lovers: |
| | | clicks = 2, | online: | clicks = 1, |
| | | conversions = 1, | clicks = 1, | conversions = 1, |
| | | revenue = 850$ | conversions = 1, | revenue = 850$ |
| | | | revenue = 850$ | |
| | | | buy cannon 60d: | |
| | | | clicks = 1, | |
| | | | conversions = 0, | |
| | | | revenue = 0$ | |

Since we are naturally also in possession of the targeting of the ad, the data is actually even richer, and includes the following fields:

TABLE 9
(further enriched ad level)

| Channel | Ad ID | Age | Gender | L&I |
|---|---|---|---|---|
| Facebook | A2 | 25-36 | Female | Fashion |

In addition, one may also have the performance data of this ad in its channel. The performance and targeting data of the ad, together with the aggregated data from the other channels (and with additional enriched ads) may be used in order to get to the exact same correlation conclusions and insights as mentioned above, for example:
80% of the people who search for “cannon 60d online” are female in the age of 25-36.
15% of the female users who converted in the last 7 days are “Gadgets' Lovers”.
5% of the female users who converted in the last 7 also looked for Product Related terms in Search Engines.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated.

What is claimed is:

1. A method comprising using at least one hardware processor for:
receiving first a set of keywords associated with a first advertising platform;
receiving second a set of keywords associated with a second advertising platform;
defining binary relations between the first and second sets of keywords;
applying formal concept analysis (FCA) to the binary relations, to produce a concept lattice; and
updating the concept lattice responsive to changes in the first or second sets of keywords.

2. The method according to claim 1, further comprising using said at least one hardware processor for:
extracting association rules from the concept lattice;
selecting extracted association rules by collaborative filtering; and
producing a cross-channel audience segmentation report.

3. The method according to claim 2, further comprising using said at least one hardware processor for effecting at least one action in at least one of said first and second advertising platforms, the at least one action selected from the group consisting of:
adding one or more keywords to an advertising campaign,
removing one or more keywords from an advertising campaign,
adding one or more negative keywords to an advertising campaign,
removing one or more negative keywords from an advertising campaign,
initiating a new advertising campaign,
stopping an advertising campaign, and
changing ad copy.

4. The method according to claim 1, wherein said updating of the concept lattice is incremental updating of the concept lattice.

5. The method according to claim 1, further comprising using said at least one hardware processor for combining similar keywords.

6. The method according to claim 1, wherein the defining of the binary relation comprises:
collecting anonymous cookie data from Internet users clicking on online advertisements; and
using the cookie data, cross-referencing activity associated with the first advertising platform and the second advertising platform.

7. The method according to claim 6, wherein the anonymous cookie data is devoid of a real identity of the Internet users.

8. The method according to claim 6, further comprising maintaining an ad-centric database which comprises the cross-referenced activity.

9. The method according to claim 6, wherein the cross-referencing comprises constructing anonymous demographic profiles of the Internet users.

10. The method according to claim 9, further comprising maintaining an ad-centric database which comprises the cross-referenced activity and the anonymous demographic profiles.

11. A computer program product for cross-channel audience segmentation, the computer program product comprising a non-transitory computer-readable storage medium having program code embodied therewith, the program code executable by at least one hardware processor for:
receiving first a set of keywords associated with a first advertising platform;
receiving second a set of keywords associated with a second advertising platform;
defining a binary relation between the first and second sets of keywords;
applying formal concept analysis (FCA) to the binary relation, to produce a concept lattice; and
updating the concept lattice responsive to changes in the first or second sets of keywords.

12. The computer program product according to claim 11, wherein the program code is further executable by the at least one hardware processor for:
extracting association rules from the concept lattice;
selecting extracted association rules by collaborative filtering; and
producing a cross-channel audience segmentation report.

13. The computer program product according to claim 12, wherein the program code is further executable by the at least one hardware processor for effecting at least one action in at least one of said first and second advertising platforms, the at least one action selected from the group consisting of:
adding one or more keywords to an advertising campaign,
removing one or more keywords from an advertising campaign,
adding one or more negative keywords to an advertising campaign,
removing one or more negative keywords from an advertising campaign,
initiating a new advertising campaign,
stopping an advertising campaign, and
changing ad copy.

14. The computer program product according to claim 11, wherein said updating of the concept lattice is incremental updating of the concept lattice.

15. The computer program product according to claim 11, wherein the program code is further executable by the at least one hardware processor for combining similar keywords.

16. The computer program product according to claim 11, wherein the defining of the binary relation comprises:
collecting anonymous cookie data from Internet users clicking on online advertisements; and
using the cookie data, cross-referencing activity associated with the first advertising platform and the second advertising platform.

17. The computer program product according to claim 16, wherein the anonymous cookie data is devoid of a real identity of the Internet users.

18. The computer program product according to claim 16, wherein the program code is further executable by the at least one hardware processor for maintaining an ad-centric database which comprises the cross-referenced activity.

19. The computer program product according to claim 16, wherein the cross-referencing comprises constructing anonymous demographic profiles of the Internet users.

20. The computer program product according to claim 19, wherein the program code is further executable by the at least one hardware processor for maintaining an ad-centric database which comprises the cross-referenced activity and the anonymous demographic profiles.
